(19) United States
(12) Patent Application Publication
(10) Pub. No.: US 2024/0365695 A1
(43) Pub. Date: Nov. 7, 2024

(54) Agricultural Application Machine with Track Adjustment

(71) Applicant: AGCO DO BRASIL SOLUÇÕES AGRÍCOLAS LTDA, Ribeireo Preto (BR)

(72) Inventors: Iuri Hennig, Canoas (BR); Jorge Luis Wolfarth, Canoas (BR); Marcelo Stahler Faleiro, Canoas (BR)

(21) Appl. No.: 18/604,928

(22) Filed: Mar. 14, 2024

(30) Foreign Application Priority Data
May 5, 2023 (GB) 2306718.4

(51) Int. Cl. A01B 63/00; A01C 23/00; B60B 35/10

(52) U.S. Cl. CPC A01B 63/006; A01C 23/008; B60B 35/1054

(57) ABSTRACT

An apparatus for working a field includes a chassis, at least one telescoping axle coupled to the chassis, wheels coupled to the telescoping axle and operably supporting the chassis, at least one sensor coupled to the chassis, and a central controller. The sensor is configured to measure sensor data indicative of a distance between at least one row of crops and at least one wheel. The central controller is configured to provide instructions to a hydraulic manifold to adjust the telescoping axle to change a distance of the at least one wheel from a centerline of the chassis based on the distance between the row and the wheel. Related methods and control systems are also disclosed.

### CROSS-REFERENCE TO RELATED APPLICATION

This application claims the benefit of the filing date of U. K. Patent Application 2306718.4, “Agricultural Application Machine with Track Adjustment,” filed May 5, 2023, the entire disclosure of which is incorporated herein by reference.

### FIELD

Embodiments of the present disclosure relate generally to working agricultural fields. More particularly, embodiments of the present disclosure relate to an agricultural application machine configured to adjust a track width during an application process, and to related control systems and methods.

### BACKGROUND

Some agricultural vehicles are configured to be operated in fields among row crops. Application machines such as self-propelled or trailed sprayers, for example, may have wheels configured to pass between crop rows and a spray boom that extends outwardly from the vehicle to spray the crop as the machine travels through the field. In order to avoid damaging the crops as the vehicle moves through the field, each of the wheels must have the proper width to travel between the rows, and the track width (the lateral distance between the wheels) must match row spacing or predefined ‘tramlines’ so that the wheels do not damage the growing crop.

Conventional agricultural sprayers offer functionality to change the track width to meet the requirements of the task at hand. Various mechanisms exist to deliver this functionality. One known system involves wheel-support assemblies mounted to a vehicle chassis by a telescopic mechanism. U.S. Pat. No. 9,290,074, “Machine suspension and height adjustment,” issued Mar. 22, 2016, discloses such a telescopic arrangement. FIG. 5 of U.S. U.S. Pat. No. 9,290,074 shows a telescoping axle arrangement with an outer axle secured to a chassis and an inner axle slidingly engaged with the outer axle allowing the wheel to shift laterally relative to the chassis. U.S. Pat. No. 11,420,677, “Mounting Assembly for a Steerable Wheel with Variable Track Width,” issued Aug. 23, 2022, discloses another system includes wheel-mounting assemblies mounted to a vehicle chassis by a telescopic mechanism and includes a separate actuation system for the steering assembly.

It is desirable to avoid damaging crops or compacting the soil proximate the crops during various procedures in an effort to control uniform germination and growth rates of the crops. However, current methods of attempting to reduce impacts to the crops during various procedures are tedious on an operator and may still damage the crops.

### BRIEF SUMMARY

According to an aspect of the disclosure, an apparatus for working a field includes a chassis, at least one telescoping axle coupled to the chassis, a plurality of wheels coupled to the telescoping axle and operably supporting the chassis, at least one sensor coupled to the chassis, the at least one sensor configured to measure sensor data indicative of a distance between at least one row of crops and at least one wheel of the plurality of wheels, and a central controller configured to provide instructions to a hydraulic manifold to adjust the at least one telescoping axle to change a distance of the at least one wheel from a centerline of the chassis based on the distance between the at least one row and the at least one wheel.

In some aspects of the disclosure, the central controller is configured to provide instructions to the hydraulic manifold to adjust a track width of the agricultural machine responsive to determining the distance between the at least one row and the at least one wheel.

In a further aspect of the disclosure, at least one sensor comprises a camera. In some aspects, the central controller is configured to determine the distance between the at least one wheel and each of a first row and a second row between which the at least one front is located.

The central controller may be configured to provide instructions to the hydraulic manifold to adjust the distance of the at least one wheel from the centerline of the chassis to center the at least one wheel between the first row and the second row. In some aspects, the central controller is configured to provide instructions to the hydraulic manifold to adjust a distance between the at least one row and each of a front wheel and a rear wheel based on the distance between the at least one row and the at least one wheel. In some aspects, the central controller is configured to independently adjust the distance between the at least one row and each of the front wheel and the rear wheel.

In an additional aspect of the disclosure, the central controller is configured to provide instructions to the hydraulic manifold to adjust the distance of the at least one wheel from the centerline of the chassis a different distance than the rear wheel from the centerline of the chassis.

In some aspects, the agricultural application machine further comprises another sensor attached to the chassis proximate another wheel and configured to determine a distance between the another wheel and at least another row. In some aspects, the central controller is configured to provide instructions to the hydraulic manifold to adjust a distance of another wheel and the centerline of the chassis responsive to determining the distance between the at least another row and the another wheel.

In an aspect of the disclosure, the central controller is configured to provide the instructions to the hydraulic manifold to independently adjust the distance between the at least one wheel and the at least one row and the distance between the at least another row and the another wheel.

In additional aspects, the at least one sensor is substantially laterally aligned with the at least one wheel. In some aspects, the agricultural machine comprises a sprayer, such as a self-propelled sprayer.

In an aspect of the disclosure, a method of operating an agricultural application machine includes receiving, with a central controller, sensor data from at least one sensor supporting a chassis of the agricultural application machine, the sensor data indicative of a distance between at least one wheel of the agricultural application machine and at least one row of crops, and responsive to receiving the sensor data, adjusting at least one telescoping axle to change a distance between the at least one wheel and a centerline of the chassis and to adjust the distance between the at least one wheel and the at least one row of crops.

In some aspects, the method further includes analyzing the sensor data to identify an edge of the at least one row of crops and another row of crops between which the wheel is located. Analyzing the sensor data may include analyzing the sensor data to identify the edge of a first row of crops and the edge of a second row of crops between which the sensor and the at least one wheel are located.

In additional aspects, adjusting the distance between the at least one wheel and the centerline of the chassis includes adjusting a first distance between a first wheel and the centerline of the chassis and adjusting a second distance between a second wheel and the centerline of the chassis by a different amount than the first distance. In other aspects, the distance the first wheel is moved from the centerline is about the same as the distance the second wheel is moved from the centerline. In some aspects, the distance between centerline and the wheels of only a first lateral side of the agricultural application machine.

In further aspects, the method further includes determining a distance between the at least one sensor and the at least one wheel, and determining a distance between the at least one wheel and the at least one row of crops.

In some aspects, the method further includes determining a target position of the at least one wheel from the at least one row of crops. Determining the target position may include determining a lateral center between two neighboring rows of crops.

In aspects of the disclosure, receiving, with the central controller, the sensor data from at least one sensor includes receiving the sensor data from a first sensor coupled to the chassis proximate a front wheel and a second sensor coupled to the chassis proximate another front wheel.

In additional aspects, adjusting a distance between the at least one wheel and a centerline of the chassis to adjust a distance between the at least one wheel and the at least one row of crops includes adjusting the distance between wheels on only one lateral side of the agricultural application machine without adjusting a distance between wheels on another lateral side of the agricultural machine and the at least one row of crops. In additional aspects, the distance between the at least one wheel and the at least one row of crops is adjusted by moving the at least one wheel laterally between parallel rows of crops.

In some aspects of the disclosure, a non-transitory computer-readable storage medium including instructions thereon that, when executed by a processor, cause the processor to analyze sensor data received from one or more sensors coupled to a chassis of an agricultural application machine to determine a location of at least one row of crops proximate at least one wheel of the agricultural application machine, determine a distance between the at least one wheel and the at least one row of crops, and provide instructions to a hydraulic manifold to adjust at least one telescoping axle to change the distance between the at least one wheel and the at least one row of crops.

In some aspects, the non-transitory computer-readable storage medium further includes instructions that, when executed by a processor, cause the processor to provide instructions to the hydraulic manifold to center the at least one wheel between the at least one row of crops and another row of crops substantially parallel to the at least one row of crops.

Within the scope of this application it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

While the specification concludes with claims particularly pointing out and distinctly claiming what are regarded as embodiments of the present disclosure, various features and advantages may be more readily ascertained from the following description of example embodiments when read in conjunction with the accompanying drawings, in which:

FIG. 1 is a simplified perspective view of a sprayer;

FIG. 2 is a simplified perspective view of a wheel mounting assembly configured to facilitate adjustment of a track of the agricultural machine of FIG. 1;

FIG. 3A-FIG. 3C are a simplified perspective view (FIG. 3A), a simplified front view (FIG. 3B), and a simplified top-down view (FIG. 3C) of portions of the sprayer of FIG. 1;

FIG. 4 is a simplified flow chart illustrating a method of operating an agricultural application machine; and

FIG. 5 is a block diagram of circuitry that may be used to implement various functions, operations, acts, processes, and/or methods.

### DETAILED DESCRIPTION

The illustrations presented herein are not actual views of any agricultural machine or portion thereof, but are merely idealized representations to describe example embodiments of the present disclosure. Additionally, elements common between figures may retain the same numerical designation.

The following description provides specific details of embodiments. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure, assembly, or sprayer. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

As used throughout, ranges are used as shorthand for describing each and every value that is within the range. Any value within the range can be selected as the terminus of the range.

From reading the following description it should be understood that the terms “longitudinal” and “transverse” are made in relation to a machine's (e.g., agricultural implement's, agricultural application machine) normal direction of travel. In other words, the term “longitudinal” equates to the fore-and-aft direction, whereas the term “transverse” equates to the crosswise direction, or left and right. As used herein, the terms “lateral” and “transverse” are used interchangeably. Furthermore, the terms “axial” and “radial” are made in relation to a rotating body such as a shaft, wherein axial relates to a direction along the rotation axis and radial equates to a direction perpendicular to the rotation axis.

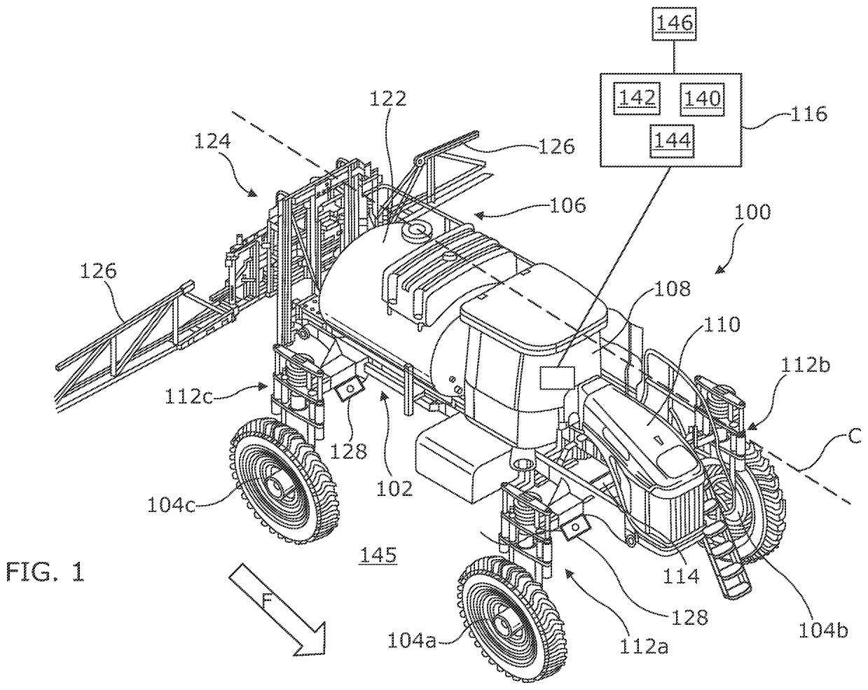

FIG. 1 is a simplified perspective view of an agricultural application machine, which may also be referred to as a sprayer 100, according to embodiments of the disclosure. The sprayer 100 may comprise a self-propelled sprayer. In other embodiments, the sprayer 100 comprises a trailed sprayer.

The sprayer 100 may include a chassis 102, at least one telescoping axle 114 coupled to the chassis 102, a plurality of wheels 104 or other ground-engaging elements coupled to the telescoping axle(s) 114 and supporting the chassis 102 above a surface of the ground. The sprayer 100 further includes an application system 106, an operator cabin 108, and an engine compartment 110. The operator cabin 108 or “cab” is supported on the chassis 102 and shown in a forward direction F relative to the application system 106, through parts of the application system 106 may alternatively be at the front of the sprayer 100. It will be understood that when referring to wheels 104 herein, each wheel 104 may include an associated tire configured to engage the ground. The wheels 104 include a pair of front wheels 104a, 104b and a pair of rear wheels 104c, 104d (not illustrated in the view of FIG. 1), collectively referred to as wheels 104.

Certain components of the sprayer 100 have been omitted from the figures for simplicity of illustration and to show certain features of the sprayer 100 that would otherwise be concealed. The engine, for example, has been omitted to illustrate components of the sprayer frame, including portions of the front axle 114. Certain hydraulic lines, such as hydraulic lines running to and from the wheel-mounting assemblies 112, are also omitted in the view of FIG. 1.

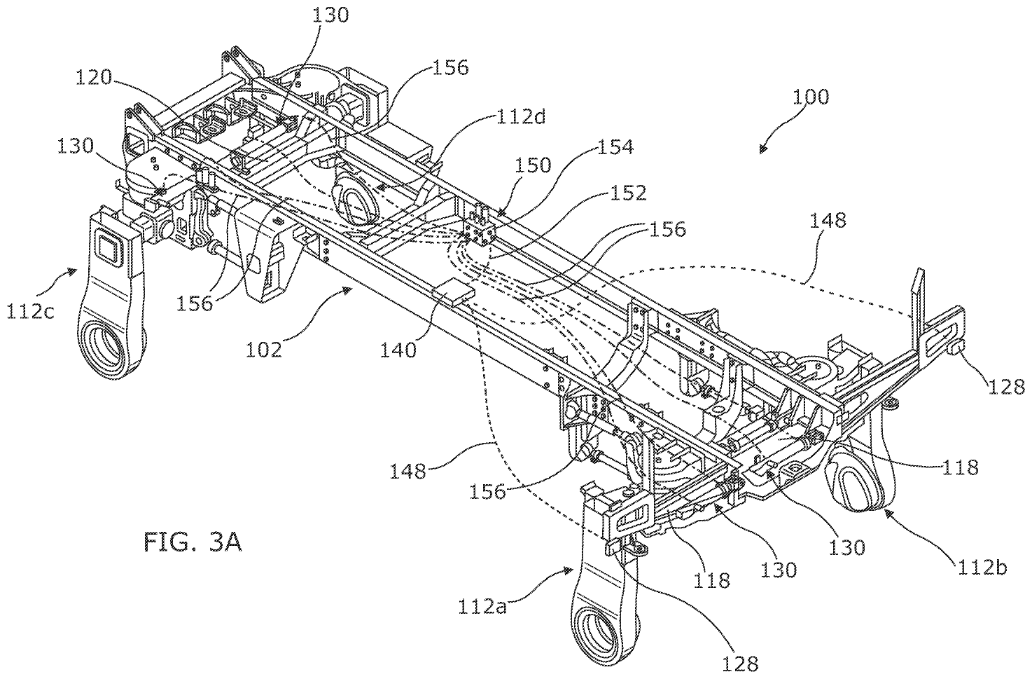

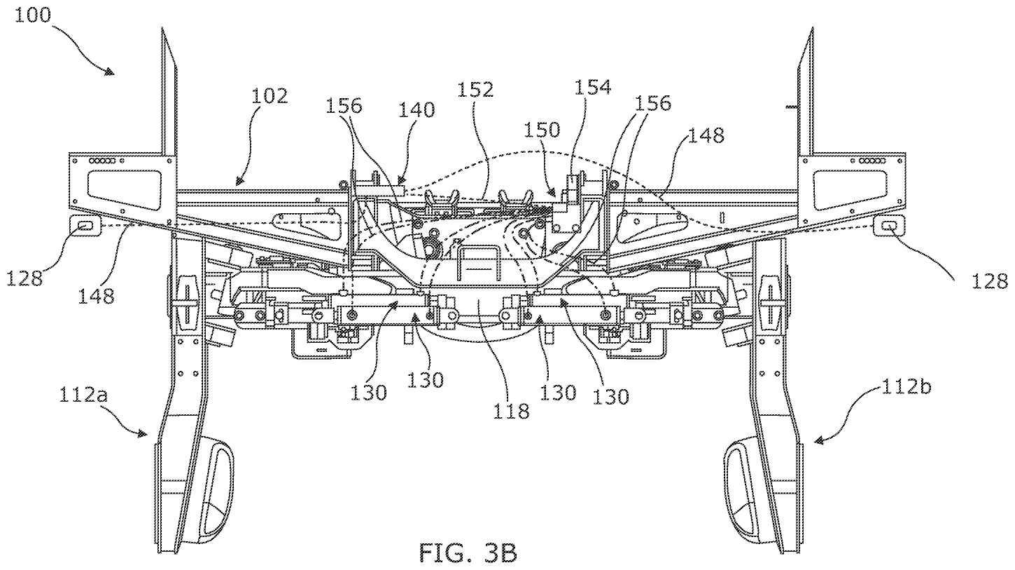

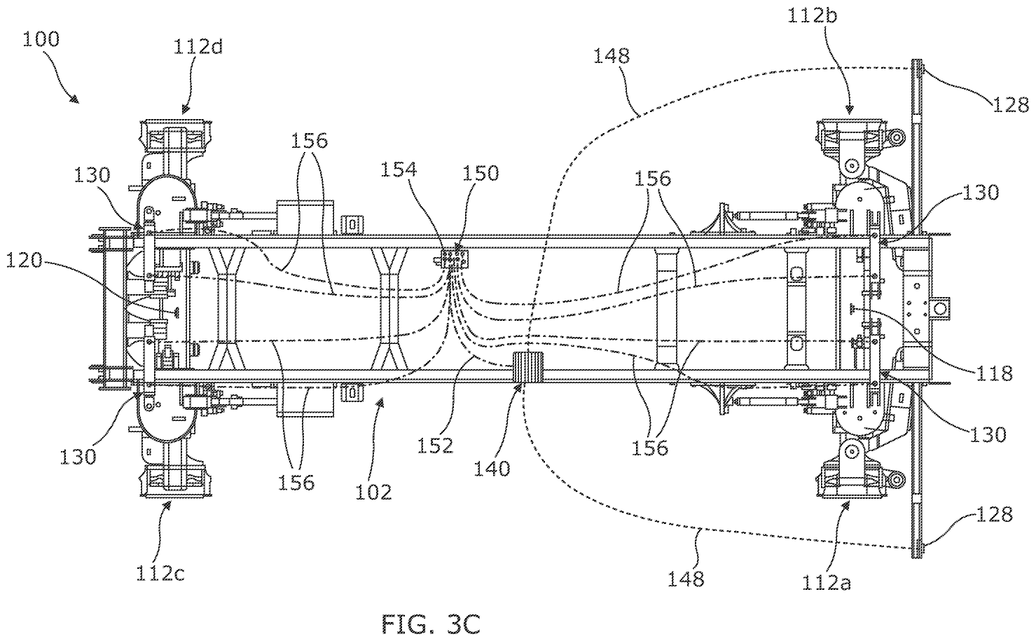

A plurality of wheel-mounting assemblies 112 including a first wheel assembly 112a, a second wheel assembly 112b, a third wheel assembly 112c, and a fourth wheel assembly 112d (FIG. 3C) interposed between the wheels 104 and the chassis 102. The wheel-mounting assemblies 112 provide suspension, track width adjustment, and steering functions, as described in U.S. Pat. No. 11,420,677.

A longitudinal centerline C of the sprayer 100 may extend through the lateral center of the sprayer 100 and divide the chassis 102 into two lateral sides having substantially the same dimensions. The left wheels 104a, 104c may be located on a first side of the longitudinal centerline C and the right wheels 104b, 104d may be located on a second side of the longitudinal centerline C.

One or more drive motors may be associated with one or more of the wheels 104 for driving rotation of the wheel or wheels relative to the chassis 102 to thereby propel the sprayer 100 in the forward direction F and the reverse direction. In the illustrated embodiment, a separate hydraulic motor is drivingly connected to each wheel 104 such that each of the wheels 104 may be driven independently to propel the sprayer 100. In other embodiments, only some of the wheels 104 are operably coupled to a drive motor. Either two or all four of the wheels 104 may be steerable. In some embodiments, the steering functionality of some of the wheels 104 may be selectively enabled and disabled. An operator may control the drive motors and steering functions of the wheels 104, including enabling and disabling the steering ability of certain of the wheels 104, from one or more user interface of, for example, an input/output (I/O) device 142 of a central controller 116 (“control unit”) in the operator cabin 108.

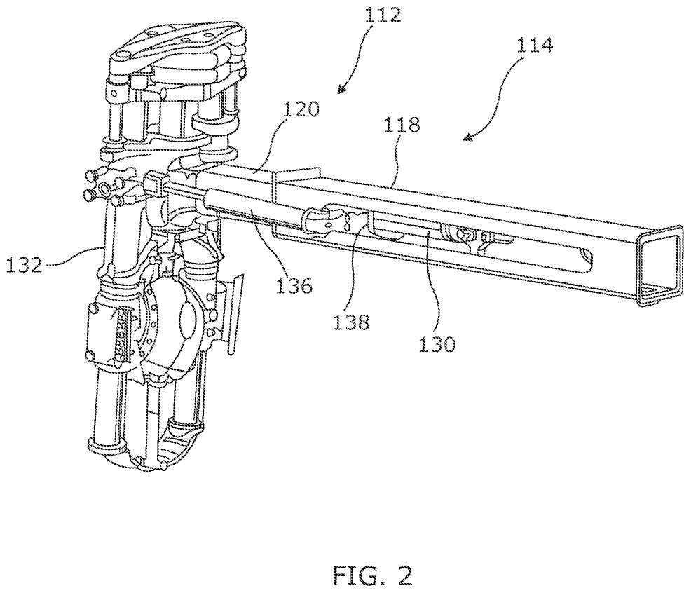

The central controller 116 includes an automatic track adjustment system (ATAS) 140 (e.g., a guidance system), at least one input/output (I/O) device 142, and, optionally, at least one additional controller 144. The central controller 116 may be configured to control one or more operations and devices of the sprayer 100 and/or the delivery system 124. In some embodiments, the sprayer 100 may include a global positioning system (“GPS”) receiver 146 mounted to the sprayer 100 and operably connected to (e.g., in communication with) the central controller 116. The GPS receiver 146 may provide GPS data to the central controller 116, such as during operation of the at least one additional controller 144 (e.g., a steering controller configured to actuate a steering actuator 136 (FIG. 2)) to facilitate steering (e.g., turning) of the wheels 104.

The at least one I/O device 142 may be configured to display information to an operator of the sprayer 100. For example, the I/O device 142 may include a user interface through which the operator activates steering control or automatic track adjustment, as described in further detail herein. The at least one additional controller 144 may include, for example, a controller for the application of product by means of the delivery system 124, a controller for steering of the sprayer 100, or another controller.

The application system 106 is supported on the chassis 102. In the illustrated embodiment, the application system 106 includes a liquid holding tank 122 and a delivery system 124 for applying a liquid from the holding tank 122 to a crop or field. The delivery system 124 includes a boom having a pair of boom arms 126 supporting hoses, pumps, and spray nozzles or similar components for dispersing or otherwise applying the contents of the tank to a crop. Alternatively, the application system 106 may be configured to apply dry material to a field and may include a hopper and a mechanism for dispersing particulate material from the hopper.

The sprayer 100 may include one or more sensors 128 coupled (e.g., mounted, attached, secured) to, for example, the chassis 102. In some embodiments, and as illustrated in FIG. 3A-FIG. 3C, the sprayer 100 includes two sensors 128. The sensors 128 may be coupled to the chassis 102 at the front of the sprayer 100. In some embodiments, the sensors 128 comprise cameras and the field of view of each of the cameras is in the forward direction F and includes the tire proximate each camera and a ground 145 surface where the tire will traverse during movement of the sprayer 100 in the forward direction F. The sensors 128 may be mounted to the chassis 102 proximate the front axle 114, such as in front of the front axle 114. In some embodiments, one sensor 128 is coupled to the sprayer 100 on a first side (e.g., the left side) proximate the left front wheel 104a and another sensor 128 is coupled to the sprayer 100 on a second side (e.g., the right side) proximate the right front wheel 104b. By way of non-limiting example, in some embodiments, the sensors 128 are coupled to the chassis 102 between each of the front wheels 104a, 104b and the longitudinal centerline C of the sprayer 100 (e.g., such as between the wheels 104 and the engine compartment 110 and between the wheels 104 and the application system 106). In other embodiments, and as described with reference to FIG. 3A-FIG. 3C, the sensors 128 are coupled to the chassis 102 at other locations, such as outside of the wheels 104. In some embodiments, at least one sensor 128 is coupled to the chassis 102 at the rear of the sprayer 100, such as proximate one or both of the rear wheels 104c, 104d. By way of non-limiting example, in some embodiments, sensors 128 proximate the rear wheels 104c, 104d may facilitate maintaining a stability of the sprayer 100 (e.g., such as by maintaining a similar distance between a row and each of the right wheels 104a, 104c, and a second row and each of the left wheels 104b, 104d).

In some embodiments, a lateral distance (e.g., in a direction substantially perpendicular to the forward direction F) between each sensor 128 and a wheel 104 nearest the sensor 128 may be less than an expected row spacing of crops to be treated with the sprayer 100. As used herein, the term “row” may be used interchangeably with a row of crops. By way of non-limiting example, the lateral distance between each sensor 128 and its corresponding nearest wheel 104 may be less than about 96.5 cm (about 38 inches), such as less than about 76.2 cm (about 30 inches), less than about 50.8 cm (about 20 inches), or less than about 38.1 cm (about 15 inches). In other embodiments, the sensors 128 are coupled to the chassis 102 such that they are laterally aligned with the wheels 104. In some such embodiments, a first sensor 128 may not be laterally spaced from the left front wheel 104a (e.g., directly in front of the left front wheel 104a) and a second sensor 128 may not be laterally spaced from the right front wheel 104b.

The sensors 128 may be operably coupled to the central controller 116, such as to the ATAS 140 of the central controller 116. As described in further detail below, the sensors 128 may individually capture sensor data indicative of a distance between one or more rows of crops and at least one wheel 104 (or associated tire) and provide the sensor data to the ATAS 140. In embodiments where the sensor 128 comprises a camera, the sensor data comprises image data (e.g., image/video data) of one or more rows of crops and at least one wheel 104 (or associated tire) in the field of view of the camera.

The sensors 128 may comprise one or more of cameras, gap sensors (configured to measure the distance between two components (e.g., a wheel 104 and at least one row), feeler gauges, or time of flight sensors. Non-limiting examples of cameras include one or more of a 3D laser scanner (LiDAR), a 2D laser scanner (LiDAR), a charge-couple device (CCD) sensor, a complementary metal oxide semiconductor (CMOS) sensor, a stereoscopic camera, a monoscopic camera, an infrared (IR) camera, a short-wave infrared (SWIR) camera, a digital single-reflex camera, or a radar camera. The cameras may be configured to capture data including one or more of relatively high resolution color images/video, relatively high resolution infrared images/video, or light detection and ranging data. In some embodiments, the cameras may be configured to capture image data at multiple focal lengths. In some embodiments, the cameras may be configured to combine multiple exposures into a single high-resolution image/video. In some embodiments, cameras may include multiple image sensors (e.g., cameras) with viewing angles facing different directions, such as a first image sensor facing in the forward direction F and a second image sensor generally facing downward toward the ground surface 145.

The telescoping axle 114 may be used for adjusting the track width of the wheels 104 to accommodate, for example, different spacing needs for row crops. As used herein, the term “track width” refers to the lateral distance between the wheels 104, such as the lateral distance between the front wheels 104a, 104b, and the lateral distance between the rear wheels 104c, 104d.

FIG. 2 is a simplified partial perspective view of one of the wheel-mounting assemblies 112 and one of the telescoping axles 114. The sprayer 100 includes four wheel-mounting assemblies 112, one associated with each of the wheels 104. Each telescoping axle 114 has an outer axle 118 and an inner axle 120 associated with the wheel 104, wherein the inner axle 120 slidingly engages the outer axle 118 to facilitate the wheel 104 to shift laterally relative to the chassis 102.

A hydraulic actuator 130 (e.g., a hydraulic cylinder) is arranged to drive the inner axle 120 inwardly and outwardly to shift the position of the associated wheel 104. In some embodiments, the hydraulic actuator 130 may be controllable by the I/O device 142. The outer axle 118 may be fixed to the chassis 102 by welds or bolts. In the illustrated embodiment, the outer axle 118 of both front wheels 104a, 104b is provided by a shared tubular structure having a rectangular cross section or internal profile in which respective inner axles 120 are telescopically received at opposite ends and the outer axle 118 of both rear wheels 104c, 104c is provided by another shared tubular structure. In other embodiments, each wheel-mounting assembly 112 comprises an outer axle that is independent of the other wheel-mounting assemblies 112.

Each wheel-mounting assembly 112 further includes a wheel-support assembly 132 connected to a hub of the associated wheel 104 (FIG. 1) and to an outboard end of one of the inner axles 120 such that the wheel 104 and the wheel-support assembly 132 shift laterally as a single unit relative to the chassis 102 when the inner axle 120 is shifted relative to the outer axle 118 to adjust the track width of the sprayer 100. In some embodiments, the wheel-support assemblies 132 include height adjustment components for raising and lowering the chassis 102 of the sprayer 100 between various operating positions.

At least some of the wheel-mounting assemblies 112 include a steering actuator 136 (e.g., a hydraulic actuator) connected to between the inner axle 120 and the wheel-support assembly 132 and coupled to a carriage 138 secured to a vertical face of the inner axle 120 to facilitate steering of the sprayer 100, as described in U.S. Pat. No. 11,420,677.

FIG. 3A-FIG. 3C are a partial perspective view (FIG. 3A), a partial front view (FIG. 3B), and a partial top-down view (FIG. 3C) of portions of the sprayer 100, in accordance with embodiments of the disclosure. FIG. 3A-FIG. 3C illustrate the ATAS 140 and operable connections between the ATAS 140 and other components of the sprayer 100. For clarity and ease of understanding the description, not all components of the sprayer 100 or the chassis 102 are illustrated in FIG. 3A-FIG. 3C.

Referring to FIG. 1, FIG. 2, and FIG. 3A-FIG. 3C, in operation and during, for example, an application process (e.g., a spraying operation), the sensors 128 may capture sensor data indicative of a distance between at least one row of crops and at least on tire. The sensors 128 may provide the sensor data to the ATAS 140, as indicated by dashed lines 148. The ATAS 140 may analyze the sensor data to identify the edge (e.g., boundary) of the rows of the crops proximate the tires and determine the distance between the rows of crops and the tires. In some embodiments, where the sensors 128 comprise cameras, the cameras capture image data of the ground 145 to identify a location of rows of crops (e.g., plants) and the tires. As a non-limiting example, the cameras may capture image data of rows or crops proximate (e.g., immediately proximate, such as laterally neighboring) the tires of the sprayer 100 and of the tires on the ground 145.

The ATAS 140 may be in operable communication with a hydraulic system 150 including a hydraulic manifold 154, as indicated by dashed lines representing control signals 152 between the ATAS 140 and the hydraulic manifold 154. In use and operation, the ATAS 140 provides the control signals 152 to the hydraulic manifold 154 of the hydraulic system 150 to control actuation of the hydraulic actuators 130 and adjust the width of the tracks.

The hydraulic manifold 154 is operably coupled (e.g., hydraulically coupled) to the hydraulic actuators 130 by hydraulic lines 156. The hydraulic lines 156 are schematically represented in FIG. 3A-FIG. 3C, but it will be understood that the hydraulic lines 156 may be connected to the hydraulic actuators 130 and the hydraulic manifold 154 by paths other than those illustrated in FIG. 3A-FIG. 3C. Each of the hydraulic actuators 130 may be coupled to two hydraulic lines 156, such as a supply line and a return line.

In some embodiments, each of the hydraulic actuators 130 includes a sensor configured to identify the position of the hydraulic actuators 130, such as a percent of the rod that is in the barrel corresponding to the amount of actuation of the hydraulic actuator 130.

FIG. 3A-FIG. 3C do not illustrate some components of the hydraulic system 150 of the hydraulic manifold 154 and the hydraulic lines 156, such as a hydraulic fluid reservoir, valves, filters, a pump, and a relief valve. The hydraulic system 150 may include suitable components for operating the hydraulic system 150 and hydraulic actuators 130.

Based on the identified rows of crops proximate the tires, the ATAS 140 and the central controller 116 may adjust the track width to reduce a likelihood of the tires compacting or damaging the crops. For example, after determining the location of the rows of the crops relative to the tires, the ATAS 140 may transmit a control signal to the hydraulic manifold 154 of the hydraulic system 150 to adjust a width of the track by moving one or more of the wheels 104 relative to the longitudinal centerline C of the sprayer 100 and one or more of the other wheels 104.

While the ATAS 140 has been described as being used with a particular type of sprayer 100 having a particular configuration including particular height and track-width adjustment mechanisms, the disclosure is not so limited, and the ATAS 140 may be used with other machines including sprayers with no height adjustment, different types of height adjustment, and different types of drack-width adjustment, as well as other types of sprayers or other utility vehicles or mobile machines.

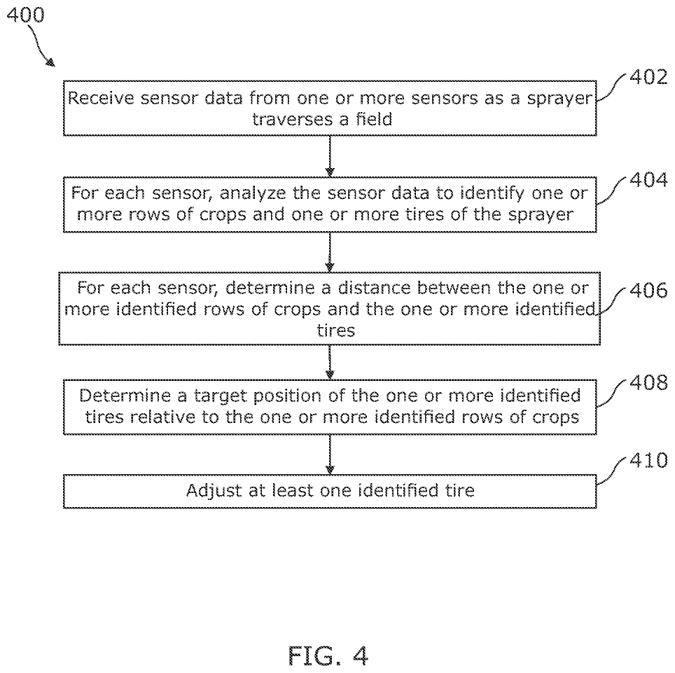

FIG. 4 illustrates a method 400 of controlling an operation of an agricultural application machine (e.g., the sprayer 100), in accordance with embodiments of the disclosure. The method 400 may be performed while performing a spraying operation through a field of crops.

The method 400 includes receiving sensor data from one or more sensors 128 of a sprayer 100 as the sprayer 100 traverses a field (e.g., the ground 145), as shown in act 402. For example, the ATAS 140 may receive the sensor data from the sensors 128. The sensor data may be indicative of (e.g., correspond to) a distance between one or more rows of crops and one or more tires. The sensor data may include data indicative of a distance between a row (e.g., directly laterally neighboring the sprayer 100) and a tire (e.g., directly laterally neighboring the sensor 128). In some embodiments, a sensor 128 is coupled to the front of the sprayer 100 and the sensor data is indicative of a distance between a front tire and a row laterally neighboring the front tire and the sensor 128. In some embodiments, a sensor is coupled to the rear of the sprayer 100 and the sensor data is indicative of a distance between a row laterally neighboring the sprayer 100 and one or both of a rear tire and a front tire.

In some embodiments, the sensor data comprises image data including one or more of images or video (e.g., video data). In other embodiments, the sensor data comprises data from one or more of a gap sensor, a feeler gauge, or a time of flight sensor. In some embodiments, receiving the sensor data from the one or more sensors 128 includes receiving sensor data from two sensors 128 including a first sensor on a first lateral side (e.g., the right side) of the sprayer 100 and a second sensor 128 on a second lateral side (e.g., the left side) of the sprayer 100. The two sensors 128 may be at the front of the sprayer 100, at the rear of the sprayer 100, or may include one sensor 128 at the front and one sensor 128 at the rear of the sprayer 128. In other embodiments, receiving the sensor data includes receiving the sensor data from four sensors 128, one proximate each wheel 104.

Responsive to receiving the sensor data with the ATAS 140, the method 400 includes, for each sensor 128, analyzing the sensor data to identify one or more rows of crops and one or more tires of the sprayer 100, as shown in act 404. The sensor data from each sensor 128 may be analyzed (e.g., by the central controller 116) to determine the location of at least one row (e.g., directly in front of, to the sides of, or both) of the sensor 128. In some embodiments, the sensor data from each sensor 128 is analyzed by the central controller 116 to determine the locations of the rows of crops directly to the left and directly to the right of the sensor 128 (e.g., the rows between which the sensor 128 is located). In some embodiments, the ATAS 140 is configured to identify an edge (e.g., a boundary) of at least one row of crops directly neighboring the sensor 128 from which the sensor data is collected. In some embodiments, analyzing the sensor data further includes, for each sensor 128, determining the location of one or more tires (e.g., neighboring the sprayer 100). In some embodiments, each sensor 128 is located proximate a corresponding wheel 104 such that the rows of crops nearest the sensor 128 correspond to the rows of crops nearest the corresponding wheel 104 of the sprayer 100. In some embodiments, analyzing the sensor data includes, for each sensor 128, determining a position of a tire relative to at least one row nearest the tire (e.g., the distance between the tire and the row nearest the tire), such as the two rows between which the sensor 128 and the tire are located.

Act 404 may include determining a location of at least one row proximate a left tire of the sprayer 100 with a first sensor 128 mounted to the left side of the sprayer 100 and determining a location of at least one row proximate a right tire of the sprayer 100 with a second sensor 128 mounted on the right side of the sprayer 100.

In embodiments where the sensor data comprises image data from one or more cameras, the ATAS 140 analyzes the image data via deep learning techniques to detect the location of the one or more rows and/or the tires of the sprayer 100 within the image data. Analyzing the image data may include performing at least one of (e.g., each of) one or more of object detection techniques (also referred to herein as “object recognition techniques” and “object identification techniques”) on the image data, image segmentation techniques on the image data, and object tracking techniques on the image data. For example, the ATAS 140 may use one or more of convolutional neural networks (CNNs), single shot detectors (SSDs), region-convolutional neural networks (R-CNNs), Faster R-CNN, Region-based Fully Convolutional Networks (R-FCNs) and other machine learning models to perform the object (e.g., row, tire) detection and classification. The foregoing models may be trained according to conventional methods to perform the object (e.g., row and tire) detection and classification. In some embodiments, the ATAS 140 may determine bounding boxes (e.g., a point, width, and height) of the detected one or more rows and one or more tires. In additional embodiments, the ATAS 140 may perform object segmentation (e.g., object instance segmentation or sematic segmentation) to associate specific pixels of the image data within the detected one or more rows and one or more tires.

In further embodiments, the ATAS 140 identifies the edges of at least one row neighboring each sensor 128 and/or the tire neighboring the sensor 128 by performing one or more shape identification (e.g., shape recognition) techniques, such as by utilizing one or more of curvature scale space (CSS), dynamic programming, shape context, Fourier descriptor, and wavelet descriptor. In additional embodiments, the ATAS 140 identifies the edges of the at least one row and/or the location of the tire by performing one or more color recognition techniques, such as one or more of a KMeans algorithm, a K-Nearest-Neighbors algorithm, or a color image segmentation technique such as multi-level thresholding, edge detection, and boundary detection. The ATAS 140 may identify the edges of at least one row and/or the location of the tire by one or more of (e.g., each of, more than one of) an object detection technique, a deep machine learning technique, an object segmentation technique, a shape identification technique, and a color recognition technique.

Responsive to identifying the one or more rows of crops and identifying the one or more tires, the method 400 may include, for each sensor 128, determining a distance between the one or more identified rows of crops (the “identified row(s)”) and the one or more identified tires (the “identified tire(s)”), as shown in act 406. In some embodiments, determining the distance between the identified row(s) and the identified tire(s) includes determining a distance between each of the rows between which the sensor 128 is located (e.g., a row to the left and a row to the right of the sensor 128) and the identified tire(s).

In some embodiments, the distance between the identified row(s) and the identified tire(s) may be determined based on the analyzed sensor data. By way of non-limiting example, where the sensor data comprises image data, the distance may be determined by utilizing an object distance estimation algorithm, such as, such as a YoloV4 Tiny model (an object detection model) developed with a darknet architecture (e.g., an open source neural network framework), or by using LiDAR utilizing light sensors to measure the distance between the identified row(s) and the identified tire(s). However, the disclosure is not so limited and the distance between the identified row(s) and the identified tire(s) may be determined utilizing the image data and based on other known techniques.

In some embodiments (such as where the sensor 128 is not laterally aligned with a tire), determining the distance between the identified row(s) and the identified tire(s) includes determining each of the distance between the sensor 128 and the identified tire; and the distance between the sensor 128 and the identified row. In some such embodiments, the central controller 116 may determine the current position of each identified tire relative to the identified row(s) based on the distance between the sensor 128 and the identified row(s) and the distance between the sensor 128 and the identified tire. For example, the distance between the identified tire and the identified row(s) may be determined based on the difference between the distance between the sensor 128 and the identified row(s) and the distance between the sensor 128 and the identified tire.

In some embodiments, determining the distance of the identified tire(s) from the identified row(s) includes determining the distance from the identified tire(s) to each of the rows directly neighboring the identified tire(s), such as the distance from the identified tire(s) to the rows between which the identified tire(s) are located.

Responsive to determining the distance of the identified tire from the identified row(s), the method 400 includes determining a target position of the identified tire(s) relative to the identified row(s), as shown in act 408. The target position of the identified tire(s) relative to identified row(s) may be determined based on the distance of the identified tire(s) from the identified row(s) determined during act 406.

In some embodiments, determining the target position of the identified tire(s) relative to the identified row(s) includes determining a distance from each identified tire to a row on each lateral side of the identified tire and laterally centering the identified tire between the rows on the lateral sides of the identified tire such that the identified tire is centered between laterally neighboring and parallel rows of crops. Centering the identified tire may include minimizing a difference between the distance between the identified tire and a first row on a first side of the identified tire and the distance between the identified tire and a second row on a second side of the identified tire.

In some embodiments, a memory of the central controller 116 includes a row spacing of the rows of the crops and determining the target position of the identified tire(s) comprises determining one half of the row spacing such that the identified tire is centered between the rows. In other embodiments, the target position of the identified tire(s) is stored in the memory and is based on the row spacing of the crop.

After determining the target position of the identified tire(s), the method 400 may include adjusting at least one identified tire to position the at least one identified tire in the target position, as shown at act 410. Adjusting the at least one identified tire position may include adjusting a distance between the identified tire and the centerline C of the sprayer 100. The position of the at least one identified tire may be adjusted based on the distance between the identified tire and the identified row(s). The at least one identified tire may be adjusted by adjusting the fluid pressure of the hydraulic actuator 130 associated with the at least one identified tire to move the wheel 104 and respective at least one identified tire closer to or farther from the longitudinal centerline C. Since each wheel 104 includes a hydraulic actuator 130 to adjust the track width independently of the other wheels 104, act 410 includes independently adjusting the track width of each of the tires.

In some embodiments, adjusting at least one identified tire position includes adjusting a track width of the sprayer 100, such as by adjusting the track width of the front wheels 104a, 104b, adjusting the track width of the rear wheels 104c, 104d, or both. In some embodiments, the track width of the front wheels 104a, 104b is adjusted a different amount than the track width of the rear wheels 104c, 104d (e.g., the track width of the front wheels 104a, 104b may be adjusted to match a change in row spacing as the sprayer 100 moves in the forward direction F; and the track width of the rear wheels 104c, 104d may be adjusted to match the row spacing as the rear wheels 104c, 104d encounter the changed spacing).

Tires on different lateral sides of the sprayer 100 may be moved by the same distance, or the tires on different lateral sides of the sprayer 100 may be moved by different distances, depending on the determined target position of the tires on each lateral side of the sprayer 100. In some embodiments, the tires on the same lateral side of the sprayer 100 are moved the same amount. In other embodiments, the tires on the same lateral side of the sprayer 100 are moved asymmetrically (e.g., a different amount). For example, the front right tire may be moved a greater amount than the rear right tire. In some embodiments, the wheels 104 of only one lateral side of the sprayer 100 are adjusted while the wheels 104 of the other lateral side are not adjusted. In some embodiments, adjusting the at least one track includes adjusting the at least one track based, at least partially, on the current position of the hydraulic actuators 130. In some embodiments, the tires of the sprayer 100 may be moved laterally between different parallel paths between the rows of crops.

The ATAS 140 may facilitate alignment of the tires between rows of crops during an application process (e.g., a spraying operation) and reduces a likelihood of damaging the crops by mechanically compressing or otherwise impacting the crops with the tires during the application process. The automatic adjustment of the tracks by the ATAS 140 substantially reduces a likelihood (e.g., prevents) driving over the crops during the application process, improving the crop yield and improving profits of the operator. In addition, automatic adjustment of the tracks reduces the time the operator would require to manually adjust the tracks or otherwise steer the sprayer to reduce damage to the crops. Furthermore, the automatic adjustment of the tracks reduces operator fatigue that may otherwise occur by continual steering of the sprayer 100 as the sprayer 100 travels along and parallel to rows of crops. In some embodiments, the sprayer 100 may be operated at a speed within a range of from about 5 km/h to about 20 km/h while automatically adjusting the distance of the tires from the rows of crops to substantially reduce or prevent damaging the crops during spraying operations. However, the disclosure is not so limited, and the sprayer 100 may be operated at a speed less than about 5 km/h or greater than about 20 km/h.

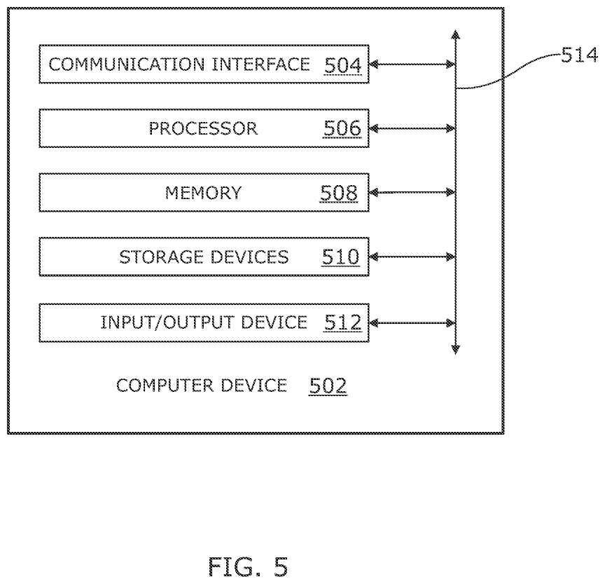

FIG. 5 is a schematic view of a computer device 502, in accordance with embodiments of the disclosure. In some embodiments, the central controller 116 comprises a computer device such as the computer device 502 of FIG. 5. The computer device 502 may include a communication interface 504, at least one processor 506, a memory 508, a storage device 510, an input/output device 512, and a bus 514. The computer device 502 may be used to implement various functions, operations, acts, processes, and/or methods disclosed herein, such as the method 400.

The communication interface 504 may include hardware, software, or both. The communication interface 504 may provide one or more interfaces for communication (such as, for example, packet-based communication) between the computer device 502 and one or more other computing devices or networks (e.g., a server). As an example, and not by way of limitation, the communication interface 504 may include a network interface controller (NIC) or network adapter for communicating with an Ethernet or other wire-based network or a wireless NIC (WNIC) or wireless adapter for communicating with a wireless network, such as a Wi-Fi.

The at least one processor 506 may include hardware for executing instructions, such as those making up a computer program. By way of non-limiting example, to execute instructions, the at least one processor 506 may retrieve (or fetch) the instructions from an internal register, an internal cache, the memory 508, or the storage device 510 and decode and execute them to execute instructions. In some embodiments, the at least one processor 506 includes one or more internal caches for data, instructions, or addresses. The at least one processor 506 may include one or more instruction caches, one or more data caches, and one or more translation look aside buffers (TLBs). Instructions in the instruction caches may be copies of instructions in the memory 508 or the storage device 510.

The memory 508 may be coupled to the at least one processor 506. The memory 508 may be used for storing data, metadata, and programs for execution by the processor(s). The memory 508 may include one or more of volatile and non-volatile memories, such as Random-Access Memory (“RAM”), Read-Only Memory (“ROM”), a solid state disk (“SSD”), Flash, Phase Change Memory (“PCM”), or other types of data storage. The memory 508 may be internal or distributed memory.

The storage device 510 may include storage for storing data or instructions. As an example, and not by way of limitation, storage device 510 may include a non-transitory storage medium described above. The storage device 510 may include a hard disk drive (HDD), Flash memory, an optical disc, a magneto-optical disc, magnetic tape, or a Universal Serial Bus (USB) drive or a combination of two or more of these. The storage device 510 may include removable or non-removable (or fixed) media, where appropriate. The storage device 510 may be internal or external to the storage device 510. In one or more embodiments, the storage device 510 is non-volatile, solid-state memory. In other embodiments, the storage device 510 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The storage device 510 may include machine-executable code stored thereon. The storage device 510 may include, for example, a non-transitory computer-readable storage medium. The machine-executable code includes information describing functional elements that may be implemented by (e.g., performed by) the at least one processor 506. The at least one processor 506 is adapted to implement (e.g., perform) the functional elements described by the machine-executable code. In some embodiments the at least one processor 506 may be configured to perform the functional elements described by the machine-executable code sequentially, concurrently (e.g., on one or more different hardware platforms), or in one or more parallel process streams.

When implemented by the at least one processor 506, the machine-executable code is configured to adapt the at least one processor 506 to perform operations of embodiments disclosed herein. For example, the machine-executable code may be configured to adapt the at least one processor 506 to perform at least a portion or a totality of the method 400 of FIG. 4. As another example, the machine-executable code may be configured to adapt the at least one processor 506 to perform at least a portion or a totality of the operations discussed for the sprayer 100 of FIG. 1. As a specific, non-limiting example, the machine-executable code may be configured to adapt the at least one processor 506 to cause the hydraulic actuators 130 of the sprayer 100 to move and adjust the position of the tracks of the sprayer 100 relative to one or more rows of crops, as described above with reference to the method 400 of FIG. 4.

The input/output device 512 may correspond to the input/output device 142 of FIG. 1 and may allow an operator of the sprayer 100 to provide input to, receive output from, the computer device 502. The input/output device 512 may include a mouse, a keypad or a keyboard, a joystick, a touch screen, a camera, an optical scanner, network interface, modem, other known I/O devices, or a combination of such I/O interfaces. The input/output device 512 may include one or more devices for the operator to toggle between an on and off position of the automatic track adjustment system described above with reference to the method 400 of FIG. 4.

In some embodiments, the bus 514 (e.g., a Controller Area Network (CAN) bus, an ISOBUS (ISO 11783 Compliant Implement Control), etc.) may include hardware, software, or both that couples components of computer device 502 to each other and to external components.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

What is claimed is:

1. An agricultural application machine comprising:
a chassis;
at least one telescoping axle coupled to the chassis;
a plurality of wheels coupled to the telescoping axle and operably supporting the chassis;
at least one sensor coupled to the chassis, the at least one sensor configured to measure sensor data indicative of a distance between at least one row of crops and at least one wheel of the plurality of wheels; and
a central controller configured to provide instructions to a hydraulic manifold to adjust the at least one telescoping axle to change a distance of the at least one wheel from a centerline of the chassis based on the distance between the at least one row and the at least one wheel.

2. The agricultural application machine of claim 1, wherein the central controller is configured to provide instructions to the hydraulic manifold to adjust a track width of the agricultural machine responsive to determining the distance between the at least one row and the at least one wheel.

3. The agricultural application machine of claim 1, wherein the at least one sensor comprises a camera.

4. The agricultural application machine of claim 1, further comprising another sensor attached to the chassis proximate another wheel and configured to determine a distance between the another wheel and at least another row.

5. The agricultural application machine of claim 4, wherein the central controller is configured to provide instructions to the hydraulic manifold to adjust a distance of the another wheel and the centerline of the chassis based on the distance between the at least another row and the another wheel.

6. The agricultural application machine of claim 5, wherein the central controller is configured to provide the instructions to the hydraulic manifold to independently adjust the distance between the at least one wheel and the at least one row and the distance between the at least another row and the another wheel.

7. The agricultural application machine of claim 1, wherein the at least one sensor is configured to determine the distance between the at least one wheel and each of a first row and a second row between which the at least one wheel is located.

8. The agricultural application machine of claim 7, wherein the central controller is configured to provide instructions to the hydraulic manifold to adjust the distance of the at least one wheel from the centerline of the chassis to center the at least one wheel between the first row and the second row.

9. The agricultural application machine of claim 1, wherein the central controller is configured to provide instructions to the hydraulic manifold to adjust a distance between the at least one row and each of a front wheel and a rear wheel based on the distance between the at least one row and the at least one wheel.

10. The agricultural application machine of claim 9, wherein the central controller is configured to independently adjust the distance between the at least one row and the each of the front wheel and the rear wheel.

11. The agricultural application machine of claim 1, wherein the at least one sensor is substantially laterally aligned with the at least one wheel.

12. A method of operating an agricultural application machine, comprising:
receiving, with a central controller, sensor data from at least one sensor coupled to a chassis of the agricultural application machine, the sensor data indicative of a distance between at least one wheel of the agricultural application machine and at least one row of crops; and
responsive to receiving the sensor data, adjusting at least one telescoping axle to change a distance between the at least one wheel and a centerline of the chassis and to adjust the distance between the at least one wheel and the at least one row of crops.

13. The method of claim 12, further comprising analyzing the sensor data to identify an edge of the at least one row of crops and another row of crops between which the at least one wheel is located.

14. The method of claim 12, wherein adjusting a distance between the at least one wheel and a centerline of the chassis comprises:
adjusting a first distance between a first wheel and the centerline of the chassis; and
adjusting a second distance between a second wheel and the centerline of the chassis by a different amount than the first distance.

15. The method of claim 12, further comprising:
determining a distance between the at least one sensor and the at least one wheel; and
determining a distance between the at least one wheel and the at least one row of crops.

16. The method of claim 15, further comprising determining a target position of the at least one wheel from the at least one row of crops.

17. The method of claim 12, wherein receiving, with a central controller, sensor data from at least one sensor comprises receiving sensor data from a first sensor coupled to the chassis proximate a front wheel and a second sensor coupled to the chassis proximate another front wheel.

18. The method of claim 12, wherein adjusting a distance between the at least one wheel and a centerline of the chassis to adjust a distance between the at least one wheel and the at least one row of crops comprises adjusting the distance between wheels on only one lateral side of the agricultural application machine without adjusting a distance between wheels on another lateral side of the agricultural machine and the at least one row of crops.

19. A non-transitory computer-readable storage medium including instructions thereon that, when executed by a processor, cause the processor to:
analyze sensor data received from one or more sensors coupled to a chassis of an agricultural application machine to determine a location of at least one row of crops proximate at least one wheel of the agricultural application machine;
determine a distance between the at least one wheel and the at least one row of crops; and
provide instructions to a hydraulic manifold to adjust at least one telescoping axle to change the distance between the at least one wheel and the at least one row of crops.

20. The non-transitory computer-readable storage medium of claim 19, further comprising instructions that, when executed by a processor, cause the processor to provide instructions to the hydraulic manifold to center the at least one wheel between the at least one row of crops and another row of crops substantially parallel to the at least one row of crops.
